(19) United States
(12) Patent Application Publication
(10) Pub. No.: US 2023/0075679 A1
(43) Pub. Date: Mar. 9, 2023

(54) TEMPERATURE MEASUREMENT METHOD, TEMPERATURE MEASUREMENT APPARATUS, ELECTRONIC DEVICE AND COMPUTER-READABLE STORAGE MEDIUM

(71) Applicant: MEGVII (BEIJING) TECHNOLOGY CO., LTD., Beijing (CN)

(72) Inventors: Yaowei ZHANG, Beijing (CN); Chen HU, Beijing (CN); Shuchang ZHOU, Beijing (CN)

(21) Appl. No.: 17/759,835

(22) PCT Filed: Sep. 30, 2020
(86) PCT No.: PCT/CN2020/119459

§ 371 Date: Jul. 29, 2022

(30) Foreign Application Priority Data
Mar. 2, 2020 (CN) 202010137546.7

(51) Int. Cl. G01J 5/53; G01J 5/48

(52) U.S. Cl. CPC G01J 5/53; G01J 5/485; G01J 2005/0077

(57) ABSTRACT

The present disclosure provides a temperature measurement method, a temperature measurement device, an electronic apparatus and a computer-readable storage medium. The method includes obtaining an image frame pair including a target object by a visible light camera and a thermal imaging camera, and a blackbody being also set in an image acquisition region of the thermal imaging camera; determining a measured temperature of the target object based on the image frame pair; performing a blackbody detection on the infrared image to obtain a detection result of the blackbody; determining a measured temperature of the blackbody based on the detection result of the blackbody and the infrared image; and correcting the measured temperature of the target object according to the measured temperature of the blackbody and a preset temperature of the blackbody, a corrected temperature being used as a temperature measurement result of the target object.

### CROSS-REFERENCE TO RELATED APPLICATION

The application claims priority to the Chinese patent application No. 202010137546.7, entitled “TEMPERATURE MEASUREMENT METHOD, DEVICE, ELECTRONIC APPARATUS AND COMPUTER-READABLE STORAGE MEDIUM”, which was filed on Mar. 2, 2020, the entire disclosure of which is incorporated herein by reference as part of the present application.

### TECHNICAL FIELD

The present disclosure relates to a field of artificial intelligence, and more particularly, to a temperature measurement method, a temperature measurement device, an electronic apparatus, and a computer-readable storage medium.

### BACKGROUND

After outbreaks such as COVID-19 and influenza, “fever” and “high temperature” have become one of the signals for screening suspected carriers. Existing temperature measurement equipment is roughly divided into three types, such as traditional mercury thermometers, hand-held contact temperature measurement equipment and infrared imaging temperature measurement equipment. In public places, in order to improve the convenience of temperature measurement, the common hand-held contact temperature measurement equipment on the market, such as a temperature gun, is usually used. However, the temperature detection through a temperature gun requires a lot of manual screening. In public places with high crowd density, it not only seriously affects the efficiency, but also increases the risk of group infection to a certain extent. In addition, using the temperature gun for temperature detection may cause large errors and inaccurate temperature measurement result due to changes in the equipment and the external environment. Based on this case, some public places such as airports and railway stations have begun to use infrared thermal imaging equipment. Although the existing infrared thermal imaging equipment improves the temperature detection efficiency and temperature measurement safety, it still causes temperature deviations due to the equipment itself and the surrounding environment, resulting in low accuracy of temperature measurement result.

### SUMMARY

In view of this case, the purpose of the present disclosure is to provide a temperature measurement method, a temperature measurement device, an electronic apparatus and a computer-readable storage medium, to alleviate the problem of inaccurate temperature measurement caused by external environment or equipment factors, and effectively improve the accuracy of temperature measurement.

To achieve the above object, an embodiment of the present disclosure provides a temperature measurement method, which includes: obtaining an image frame pair comprising a target object by a visible light camera and a thermal imaging camera, wherein the image frame pair comprises a visible light image and an infrared image collected simultaneously, and a blackbody being also set in an image acquisition region of the thermal imaging camera; determining a measured temperature of the target object based on the image frame pair; performing a blackbody detection on the infrared image to obtain a detection result of the blackbody, the detection result comprising position information of the blackbody in the infrared image; determining a measured temperature of the blackbody based on the detection result of the blackbody and the infrared image; and correcting the measured temperature of the target object according to the measured temperature of the blackbody and a preset temperature of the blackbody, a corrected temperature being used as a temperature measurement result of the target object.

Optionally, the determining the measured temperature of the target object based on the image frame pair comprises: performing a target object detection on the visible light image in the image frame pair to obtain position information of the target object in the visible light image; determining position information of the target object in the infrared image based on a spatial positional relationship between the visible light camera and the thermal imaging camera, and the position information of the target object in the visible light image; determining the measured temperature of the target object according to the position information of the target object in the infrared image.

Optionally, the detection result of the blackbody further comprises a state of the blackbody, and the state comprises an occlusion state and a non-occlusion state. The step of detecting the blackbody of the infrared image by a preset neural network model to obtain the detection result of the blackbody includes: detecting the blackbody of the infrared image by the preset neural network model to obtain the position information of the blackbody in the infrared image and a confidence level of the position information; determining the state of the blackbody according to the position information of the blackbody in the infrared image and the confidence level of the position information.

Optionally, the determining the state of the blackbody according to the position information of the blackbody in the infrared image and the confidence level of the position information, comprises: determining a probability of the blackbody being blocked is 100% in a case where the position information of the blackbody in the infrared image is empty; determining the probability of the blackbody being blocked based on the confidence level of the position information in a case where the position information of the blackbody in the infrared image is non-empty; and determining the state of the blackbody according to the probability of the blackbody being blocked.

Optionally, the determining the probability of the blackbody being blocked based on the confidence level of the position information, comprises: determining the probability of the blackbody being blocked corresponding to the confidence level of the position information according to a corresponding relationship between the confidence level of preset position information and the probability of the blackbody being blocked, and in the corresponding relationship, the confidence level of the position information is negatively correlated with the probability of the blackbody being blocked.

Optionally, the determining the state of the blackbody according to the probability of the blackbody being blocked, comprises: determining the state of the blackbody is the occlusion state in a case where the probability of the blackbody being blocked is greater than a preset threshold; and determining the state of the blackbody is the non-occlusion state in a case where the probability of the blackbody being blocked is less than the preset threshold.

Optionally, the determining the measured temperature of the blackbody based on the detection result of the blackbody and the infrared image, comprises: in a case where the state of the blackbody is an occlusion state, obtaining a historical measured temperature of the blackbody in an adjacent specified time period before acquisition time of the infrared image, and determining the measured temperature of the blackbody corresponding to the acquisition time based on the historical measured temperature of the blackbody; and in a case where the state of the blackbody is a non-occlusion state, determining a region which the blackbody is located in the infrared image based on the position information of the blackbody in the infrared image, and determining temperature of the region represented by the infrared image as the measured temperature of the blackbody corresponding to the acquisition time of the infrared image.

Optionally, the correcting the measured temperature of the target object according to the measured temperature of the blackbody and the preset temperature of the blackbody, comprises: using a difference between the measured temperature of the blackbody and the preset temperature of the blackbody as a temperature correction value; and correcting the measured temperature of the target object based on the temperature correction value.

The embodiment of the present disclosure also provides a temperature measurement device, which comprises: an image acquisition module, configured to obtain an image frame pair comprising a target object by a visible light camera and a thermal imaging camera, wherein the image frame pair comprises a visible light image and an infrared image collected simultaneously, and a blackbody is also set in an image acquisition region of the thermal imaging camera; an object temperature determination module, configured to determine a measured temperature of the target object based on the image frame pair; a blackbody detection module, configured to perform a blackbody detection on the infrared image to obtain a detection result of the blackbody, wherein the detection result comprises position information of the blackbody in the infrared image; a blackbody temperature determination module, configured to determine a measured temperature of the blackbody based on the detection result of the blackbody and the infrared image; and a temperature correction module, configured to correct the measured temperature of the target object according to the measured temperature of the blackbody and a preset temperature of the blackbody; a corrected temperature is used as a temperature measurement result of the target object.

The embodiment of the present disclosure also provides an electronic apparatus, which comprises a processor, a storage device, an input device, an output device, an image acquisition device and a bus system. A computer program is stored on the storage device, and when executed by the processor, the computer program executes the method as described in any one of the previous embodiments, the input device is configured as a device for a user to input instructions, the output device is configured to output information to the outside, the image acquisition device is configured to capture an image desired by the user and store the captured image in the storage device for use by other components, and the bus system is configured to interconnect the above other components.

The embodiment of the present disclosure also provides a computer-readable storage medium, the computer readable storage medium stores computer program instructions, application programs and data used and/or generated by the application programs. When the computer program instructions are run by a processor through the application programs, the steps of the method described in any one of the foregoing embodiments are performed, and the data used and/or generated in this process is stored.

The present disclosure provides a temperature measurement method, a temperature measurement device, an electronic apparatus and a computer-readable storage medium. An image frame pair including a target object (including a visible light image and an infrared image collected simultaneously) is obtained by a visible light camera and a thermal imaging camera, and a blackbody is also set in an image acquisition region of the thermal imaging camera; Then, the measured temperature of the target object is determined based on the image frame pair, and the infrared image is detected by the blackbody, the detection result of blackbody (including the position information and state of blackbody in infrared image) is obtained, then the measured temperature of blackbody is determined based on the detection result and infrared image, so as to correct the measured temperature of the target object according to the measured temperature and the preset temperature of the blackbody, and finally take the corrected temperature as the temperature measurement result of the target object. In this way, the measured temperature of the target object is corrected by using the characteristics of the blackbody itself, and the temperature measurement error caused by the external environment and the temperature measurement equipment itself is corrected, thus improving the accuracy of the temperature measurement.

Other features and advantages of the embodiment of the present disclosure will be set forth in the description that follows, or some features and advantages can be inferred from the description or determined without doubt, or can be learned by practicing the above techniques of the embodiment of the present disclosure.

In order to make the above objects, features and advantages of the present disclosure more obvious and understandable, the following preferred embodiments will be described in detail with reference to the attached drawings.

### BRIEF DESCRIPTION OF THE DRAWINGS

In order to clearly illustrate the technical solutions of the embodiments of the present disclosure, the drawings of the embodiments will be briefly described in the following; it is obvious that the described drawings are only related to some embodiments of the present disclosure, and for those of ordinary skill in this field, other drawings can be obtained according to these drawings without creative labor.

FIG. 1 is a structural schematic diagram of an electronic apparatus provided by an embodiment of the present disclosure;

FIG. 2 is a flow chart of a temperature measurement method provided by an embodiment of the present disclosure;

FIG. 3 is a flow chart of another temperature measurement method provided by an embodiment of the present disclosure.

FIG. 4 is a structural schematic diagram of a temperature measurement device provided by an embodiment of the present disclosure.

### DETAILED DESCRIPTION

In order to make objects, technical solutions, and advantages of the embodiments of the present disclosure apparent, the technical solutions of the present disclosure will be described in connection with drawings. Apparently, the described embodiments are just a part but not all of the embodiments of the present disclosure.

Considering that the temperature measurement equipment in the prior art is inaccurate in temperature measurement due to external environment or equipment factors, in order to solve this problem, the embodiments of the present disclosure provide a temperature measurement method, a temperature measurement device, an electronic apparatus, and a computer-readable storage medium, the technology may be applied to an equipment that needs to measure temperature, such as a temperature measurement equipment. For ease of understanding, the following describes the embodiments of the present disclosure in detail.

Referring to FIG. 1, an example electronic apparatus 100 for implementing a temperature measurement method, a temperature measurement device, an electronic apparatus, and a computer-readable storage medium of the embodiments of the present disclosure is described.

In the structural schematic diagram of an electronic apparatus as shown in FIG. 1, the electronic apparatus 100 includes one or more processors 102, one or more storage devices 104, an input device 106, an output device 108, an image acquisition device 110, and a bus system 112 and/or other forms of connection mechanisms (not shown) interconnecting the other components described above. It should be noted that the components and structures of the electronic apparatus 100 as shown in FIG. 1 are only exemplary and not restrictive, and the electronic apparatus may also have other components and structures as required.

The processor 102 may be configured to be implemented in at least one hardware form of a digital signal processor (DSP), a field programmable gate array (FPGA), and a programmable logic array (PLA), may be configured as one or more combination of a central processing unit (CPU), a graphics processing unit (GPU), or other form of processing unit with data processing capability and/or instruction execution capability, and may be configured to control other components in the electronic apparatus 100 to perform the desired functions.

The storage device 104 may include one or more computer program products, which may include various forms of computer-readable storage medium, such as a volatile memory and/or a non-volatile memory. The volatile memory may include, for example, a random access memory (RAM) and/or a cache memory, or the like. The non-volatile memory may include, for example, a read only memory (ROM), a hard disk, a flash memory, and the like. One or more computer program instructions may be stored on the computer-readable storage medium, and the processor 102 may execute the program instructions to implement the client functions (implemented by the processor) and/or other desired functions in the embodiments of the present disclosure described below. Various application programs and various data, such as various data used and/or generated by the application program, may also be stored in the computer-readable storage medium.

The input device 106 may be configured as a device used by a user to input instructions, and may include one or more of a keyboard, mouse, microphone, touch screen, and the like.

The output device 108 may be configured to externally (eg, a user) output various information (eg, images or sounds), and may include one or more of a display, a speaker, and the like.

The image acquisition device 110 may be configured to capture user-desired images (eg, photos, videos, etc.) and store the captured images in the storage device 104 for use by other components.

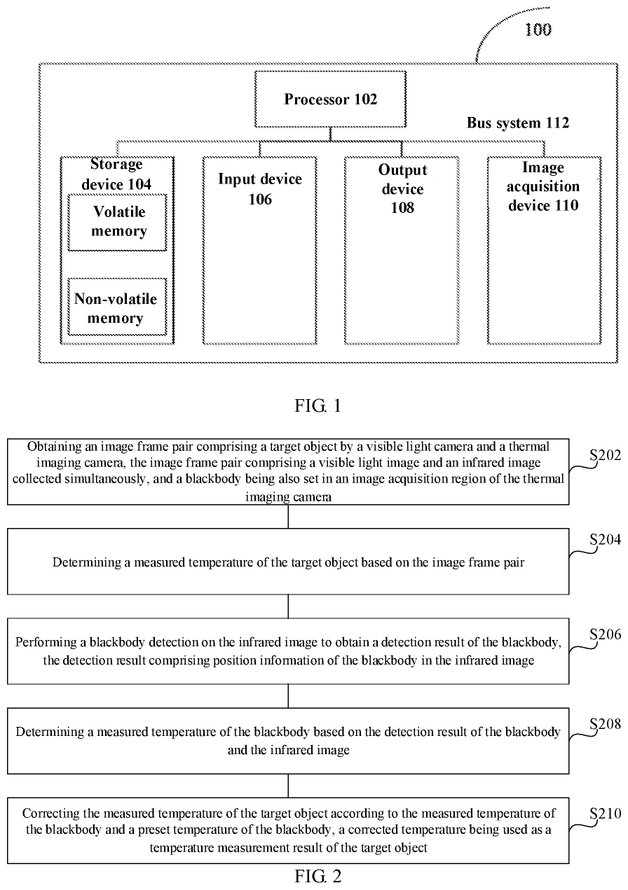

Exemplarily, the exemplary electronic apparatus for implementing the temperature measurement method, the temperature measurement device, the electronic apparatus, and the computer-readable storage medium according to the embodiments of the present disclosure may include smart terminals, such as temperature measurement cameras, smart phones, wearable electronic apparatus, etc. Referring to the schematic flowchart of a temperature measurement method as shown in FIG. 2, the method mainly includes the following steps S202 to S210.

Step S202: obtaining an image frame pair comprising a target object by a visible light camera and a thermal imaging camera, the image frame pair comprising a visible light image and an infrared image collected simultaneously, and a blackbody being also set in an image acquisition region of the thermal imaging camera.

The visible light is the part of an electromagnetic spectrum that can be perceived by the human eye. Generally, a wavelength of the visible light is between 400 and 760 nm. The visible light image obtained by the visible light camera is also an image that the human eye can see. The visible light image obtained by the visible light camera can intuitively reflect the current state presented by the image acquisition region of the visible light camera, such as the position of the target object located in the image acquisition region, etc. The target object includes, but is not limited to, a human body and other natural creatures that can be used as infrared radiation sources. Taking the human body as an example, because the human body is a natural biological infrared radiation source, the human body may continuously emit and absorb infrared radiation to the surrounding, and the temperature distribution of the normal human body has certain stability and characteristics. A thermal imaging camera (called an infrared camera) may acquire an infrared image reflecting the body temperature. In an embodiment of the present disclosure, a visible light image may be collected by a visible light camera, and an infrared image may be collected by a thermal imaging camera, and then the visible light image and the infrared image collected by the visible light camera and the thermal imaging camera at the same moment may be used as a set of image frame pair. In practical applications, the visible light camera and the thermal imaging camera may be time-synchronized in advance.

A blackbody is an idealized object in the thermal radiation, with three characteristics of completely absorbing external radiation of any wavelength without any reflection, having an absorption ratio of 1, and absorbing all incident radiation of any wavelength at any temperature at any condition. Therefore, the blackbody may be regarded as a kind of constant temperature body. In the embodiment of the present disclosure, the blackbody is set in the image acquisition region of the thermal imaging camera, and then the temperature of the blackbody measured by the temperature measurement device is collected in real time, and the difference between the measured temperature of the blackbody and the temperature set by the blackbody itself is the deviation of environment or temperature caused by the device itself. For example, when the environment temperature is low, the measured temperature obtained by a sensor when the sensor extract infrared data may be lower than the real temperature, or when a device runs for a long time, the temperature of the device may increase, so that the measured temperature is higher than the real temperature. All of these will lead to inaccurate measurement of the temperature of the device. By setting the blackbody in the image acquisition region of the thermal imaging camera, the constant temperature characteristic of the blackbody may be used to determine whether the measured temperature of the device has a temperature deviation.

Step S204: determining a measured temperature of the target object based on the image frame pair.

It can be understood that the positions of the visible light camera and the infrared camera are different, so an image collection range has a certain deviation, so the images collected for the same region are also different, that is, positions of the same target object in the visible light image and the infrared image are also different, but there will be a certain corresponding relationship. On the basis that the visible light image and the infrared image in the image frame pair are collected at the same time, the corresponding relationship between the visible light image and the infrared image may be determined according to the spatial position relationship between the visible light camera and the infrared camera. For example, to identify a first position region of a target person A in the visible light image, and then based on the correspondence between the visible light image and the infrared image, the first position region is converted into a second position region in the infrared image, and a second position region is a position of the target person A in the infrared image, so that the temperature of the second position region displayed in the infrared image is taken as a measured temperature of the target person A.

Step S206: performing a blackbody detection on the infrared image to obtain a detection result of the blackbody, the detection result comprising position information of the blackbody in the infrared image.

Optionally, the position of the blackbody may be checked and calibrated manually to realize the blackbody detection of the infrared image.

Considering that in practical applications, the position of the device that needs a blackbody calibration may move or the position of the blackbody may move due to various reasons, and the blackbody detection result will change. In order to better save the cost of calibrating the blackbody, and avoid manual calibration error, and also try to improve the efficiency of the blackbody detection, the embodiment of the present disclosure may optionally use a preset neural network model to perform the blackbody detection on infrared images, and the neural network model may be implemented based on a target detection algorithm, such as SSD (Single Shot MultiBox Detector), YOLO (You Only Look Once: Unified, Real-Time Object Detection) and Convolutional Neural Networks (CNN) and other neural network models. Performing the blackbody detection on an infrared image, that is, performing a target detection on the blackbody in the infrared image, may obtain the location information of the blackbody in the infrared image through the obtained result, and the location information may include location coordinates of the blackbody in the infrared image. Of course, in practical applications, if the position information of the blackbody is empty (for example, there is no position coordinate output), it is considered that the blackbody is not detected in the infrared image.

The embodiment of the present disclosure automatically detects the blackbody through the neural network model, which effectively improves the efficiency and reliability of the blackbody calibration, and reduces the limitation of the blackbody position, there is no need to keep the blackbody position unchanged, and the blackbody position may be flexibly adjusted according to the demand, as long as the blackbody is located in the image acquisition region of the thermal imaging camera, even if the positional relationship between the blackbody and the thermal imaging camera changes, accurate blackbody detection results may be obtained through the neural network model to avoid inaccurate temperature detection due to the change of the blackbody position.

Step S208: determining a measured temperature of the blackbody based on the detection result of the blackbody and the infrared image.

According to the carried position information of the blackbody in the infrared image in the detection result, the region where the blackbody is in the infrared image is determined, and the temperature of the region presented in the infrared image is the measured temperature of the blackbody.

Step S210: correcting the measured temperature of the target object according to the measured temperature of the blackbody and a preset temperature of the blackbody, a corrected temperature being used as a temperature measurement result of the target object.

Optionally, for example, the preset temperature of the blackbody may be set between 30 degrees and 40 degrees. Specifically, it may be empirically set according to the environment where the blackbody is located. For example, when it is outdoors, the preset temperature of the blackbody may be set as 34 degrees. Because the blackbody has a constant temperature characteristic, when the measured temperature of the blackbody is different from the preset temperature of the blackbody, it means that there is a deviation in the measured temperature of the temperature measurement device. For example, when the preset temperature of the blackbody is 34 degrees, and the measured temperature of the blackbody obtained by the temperature measurement device is 34.4 degrees, it may be determined that the temperature measurement result of the temperature measurement device is 0.4 degrees higher than the actual temperature. So, the correction value for the correction of the measured temperature of target person A is 0.4 degrees. Assuming that the measured temperature of the target person A obtained by the thermal imaging camera is 37.6 degrees, the corrected temperature is 37.2 degrees. The corrected temperature of 37.2 degrees is used as the temperature measurement result of the target person A, thereby avoiding falsely reporting the target person A as a high-risk person. The above-described correction of the measured temperature of the target object by using the constant temperature characteristic of the blackbody can reduce the temperature measurement error caused by equipment or environmental factors and improve the accuracy of temperature measurement.

The above-described temperature measurement method provided by the embodiment of the present disclosure uses the characteristics of the blackbody to correct the measured temperature of the target object and calibrates the temperature measurement error caused by the external environment and the temperature measurement device itself, thereby improving the temperature measurement accuracy. The above method can realize the automatic detection of blackbody based on the neural network model, without manual calibration of the position of the blackbody, thus avoiding the cumbersome and human error of manual calibration, enabling the measured temperature of the blackbody more real and reliable, further improving the reliability of temperature correction, enabling the corrected temperature measurement results are more accurate.

For ease of understanding, the embodiment of the present disclosure provides a specific implementation manner of determining the measured temperature of the target object based on the image frame pair, that is, the above step S204 may be performed with reference to the following steps (1) to (3).

In step (1), the target object detection is performed on the visible light image in the image frame pair, and position information of the target object in the visible light image may be obtained; a target detection algorithm may be used to detect the target object on the visible light image. The target detection algorithm may select single target detection or multi-target detection according to the actual situation, which is not limited here. Taking multi-target detection as an example, multiple target objects are detected and recognized in the visible light image, and the position information of each target object is determined on the visible light image.

In step (2), based on the spatial position relationship between the visible light camera and the thermal imaging camera, and the position information of the target object in the visible light image, the position information of the target object in the infrared image is determined. For example, knowing the first position coordinates of the target person A in the visible light image, according to the spatial positional relationship between the visible light camera and the thermal imaging camera, the first position coordinates are projected and converted to the second position coordinates in the infrared image, to obtain the position information of the target person A in the infrared image.

In step (3), the measured temperature of the target object is determined according to the position information of the target object in the infrared image. That is, the temperature corresponding to the target object in the region where the infrared image is located is determined as the measured temperature of the target object.

Considering that the blackbody may be blocked, for example, in public places, such as train stations, pedestrians may block the blackbody in whole or in part. In order to avoid using a temperature of the object that blocks the blackbody as the measured temperature of the blackbody as much as possible, thus affecting the accuracy of temperature measurement, in this embodiment of the present disclosure, the detection result of the blackbody obtained through the preset neural network model detection also includes the state of the blackbody, which includes an occlusion state and a non-occlusion state. Based on this case, the above step S206 may optionally include the following step 1 and step 2:

Step 1: performing the blackbody detection on the infrared image by using a preset neural network model to obtain the position information of the blackbody in the infrared image and a confidence level of the position information.

For example, the input of the preset neural network model is an entire infrared image, and the output is the position information of the detected blackbody (such as the position coordinates of the blackbody) and the confidence level of the position information of the blackbody. For example, if the position information of the detected blackbody is in the lower left corner of the infrared image, the confidence level is 90%, the probability that the blackbody may be in the lower left corner of the infrared image is 90%.

Optionally, by performing the blackbody detection on the infrared image through a preset neural network model, a shape or a size of the blackbody may also be obtained. The shape of the blackbody may include a circle or a square. In practical applications, it may be judged whether the distance between the blackbody and the thermal imaging camera is reasonable based on the proportion of the detected blackbody size in the infrared image. If the blackbody is too close to the thermal imaging camera, the proportion of the blackbody in the entire infrared image is too large, and the target object may not be detected normally; if the blackbody is too far from the thermal imaging camera, the proportion of the blackbody in the infrared image is too small, then it may be more difficult to accurately determine the measured temperature of the blackbody.

Step 2: determining a state of the blackbody according to the position information of the blackbody in the infrared image and the confidence level of the position information. When the state of the blackbody includes an occlusion state and a non-occlusion state, the embodiment of the present disclosure optionally provides a specific implementation of step 2, which may be implemented with reference to the following steps 2.1 to 2.3.

Step 2.1: determining a probability of the blackbody being blocked is 100% if the position information of the blackbody in the infrared image is empty.

Optionally, if the position information of the blackbody in the infrared image is empty, that is, no blackbody is detected in the infrared image, but the blackbody is in the image acquisition range of the thermal imaging camera. If no blackbody is detected, determine the probability of the blackbody being blocked at this time is 100%, that is, the state of the blackbody is the occlusion state.

Step 2.2: determining a probability of the blackbody being blocked based on the confidence level of the position information if the position information of the blackbody in the infrared image is non-empty.

Optionally, if the position information of the blackbody in the infrared image is non-empty, the probability of the blackbody, which corresponds to the confidence level of the position information, being blocked may be determined according to the corresponding relationship between the confidence level of the preset position information and the occlusion probability. In the corresponding relationship between the confidence level of the position information and the probability of the blackbody being blocked, the confidence level of the position information is negatively correlated with the probability of the blackbody being blocked, that is, the lower the confidence level of the position information, the higher the occlusion probability. For example, if the confidence level of the location information is 15%, the probability of the blackbody being blocked in the corresponding relationship is set to 85%. It should be noted that the above examples are merely illustrative and should not be regarded as limiting.

Step 2.3: determining the state of the blackbody according to the probability of the blackbody being blocked.

If the probability of the blackbody being blocked is greater than the preset threshold, the state of the blackbody is determined to be an occlusion state; if the probability of the blackbody being blocked is less than the preset threshold, the state of the blackbody is determined to be a non-occlusion state. The preset threshold may be set according to an empirical value.

Based on the blackbody detection results that are known to carry the position information of the blackbody and whether the blackbody is blocked, the measured temperature of the blackbody may be further determined in combination with the infrared image, which may be achieved by referring to the following steps (1) and (2).

In step (1), if the state of the blackbody is the occlusion state, a historical measured temperature of the blackbody in an adjacent specified time period before the acquisition time of the infrared image is obtained, and the measured temperature of the blackbody corresponding to the acquisition time is determined based on the historical measured temperature of the blackbody. The adjacent specified time period may be set flexibly. The measured temperature may be an average detection temperature of multiple frames of images of non-occluded blackbody in the adjacent specified time period before the current infrared image acquisition, or an average detection temperature of all frames of images of the blackbody in the adjacent specified time period before the current infrared image acquisition. Because the measured temperature of the blackbody in the occluded state before the acquisition time has been corrected by the historical frame temperature, the average measured temperature of all frames in a time period before the acquisition time may also be used as the measured temperature at the acquisition time.

In step (2), if the state of the blackbody is the non-occlusion state, determine a region which the blackbody is located in the infrared image based on the position information of the blackbody in the infrared image, determining temperature of the region represented by the infrared image as the measured temperature of the blackbody corresponding to the acquisition time of the infrared image.

After the measured temperature of the blackbody is determined through the above steps, the difference between the measured temperature of the blackbody and the preset temperature of the blackbody may be used as the temperature correction value, and the measured temperature of the target object may be corrected based on the temperature correction value, to avoid the problem of inaccurate measured temperature of the target object due to environmental or equipment factors and improve the accuracy of temperature measurement.

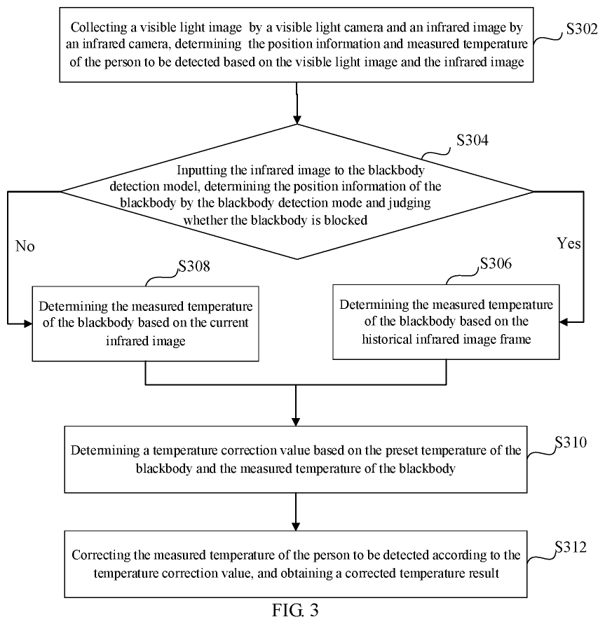

Based on the above embodiments of the present disclosure, the embodiments of the present disclosure provide a specific example of applying the above temperature measurement method. Referring to the flow chart of another temperature measurement method as shown in FIG. 3, the method mainly includes the following steps S302 to S314.

In step S302, a visible light image may be collected by a visible light camera, and an infrared image may be collected by an infrared camera (ie, the thermal imaging camera). Based on the visible light image and the infrared image, the position information and measured temperature of a person to be detected may be determined.

In step S304, the infrared image is input to the blackbody detection model, the position information of the blackbody is determined by the blackbody detection model, and it is judged whether the blackbody is blocked. If yes, go to step S306; if not, go to step S308. Specifically, the blackbody is set in the acquisition region of the infrared camera, and the blackbody detection model may detect the position of the blackbody in the infrared image and the confidence level of the blackbody at the position, to obtain the probability of the blackbody being blocked based on the confidence level of the position, and then determine whether the blackbody is occluded according to the probability of the blackbody being blocked.

In step S306, the measured temperature of the blackbody is determined based on the historical infrared image frames. The historical infrared image frame may be the previous frame or multiple frames of non-occluded infrared images before the current infrared image acquisition time or may be all infrared images collected within a time period before the current infrared image acquisition time. Optionally, the average value of the blackbody detection temperatures of the historical infrared image frames may be used as the measured temperature of the current occluded blackbody.

In step S308, the measured temperature of the blackbody is determined based on the current infrared image. If it is determined that the blackbody is not blocked, the temperature of the region where the blackbody is located in the current infrared image is detected by the blackbody detection model, and served as the current measured temperature of the blackbody.

In step S310, a temperature correction value may be determined based on the preset temperature of the blackbody and the measured temperature of the blackbody. Specifically, the temperature correction value is a value obtained by making a difference between the preset temperature of the blackbody and the detection temperature of the blackbody.

In step S312, the measured temperature of the person to be detected is corrected according to the temperature correction value, and a corrected temperature result is obtained. By correcting the temperature of the person, the problem of inaccurate temperature measurement caused by the surrounding environment or equipment factors may be alleviated, and the accuracy of temperature detection may be improved.

The temperature measurement method provided by the embodiment of the present disclosure, on the one hand, the constant temperature characteristic of the blackbody is used to correct the measured temperature of the target object and calibrate the temperature measurement error caused by the external environment and the temperature measurement equipment, on the other hand, the automatic detection of the blackbody is realized based on the neural network model, without manual calibration of the position of the blackbody, thus avoiding the cumbersome and human error of manual calibration, enabling the measured temperature of the blackbody more real and reliable, further improving the reliability of temperature correction, enabling the corrected temperature measurement results more accurate.

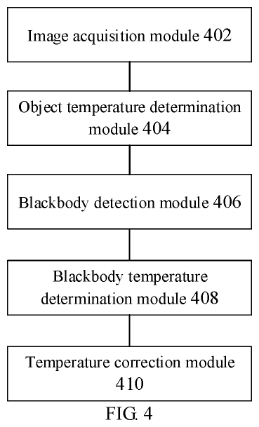

For the temperature measurement method provided by the embodiment of the present disclosure, the embodiments of the present disclosure provide a temperature measurement device. Referring to the schematic structural diagram of a temperature measurement device as shown in FIG. 4, the device includes the following modules:

An image acquisition module 402, may be configured to obtain an image frame pair comprising a target object by a visible light camera and a thermal imaging camera. The image frame pair comprises a visible light image and an infrared image collected simultaneously, and a blackbody is also set in an image acquisition region of the thermal imaging camera.

An object temperature determination module 404, may be configured to determine a measured temperature of the target object based on the image frame pair.

A blackbody detection module 406, may be configured to perform a blackbody detection on the infrared image to obtain a detection result of the blackbody; the detection result comprises position information of the blackbody in the infrared image.

A blackbody temperature determination module 408, may be configured to determine a measured temperature of the blackbody based on the detection result of the blackbody and the infrared image.

A temperature correction module 410, may be configured to correct the measured temperature of the target object according to the measured temperature of the blackbody and a preset temperature of the blackbody; a corrected temperature is used as a temperature measurement result of the target object.

The above-described temperature measurement device provided by the embodiments of the present disclosure correct the measured temperature of the target object by using the characteristics of the blackbody and calibrates the temperature measurement error caused by the external environment and the temperature measurement device, thereby improving the temperature measurement accuracy.

Optionally, the above-described object temperature determination module 404 may be configured to as follows: perform a target object detection on the visible light image in the image frame pair to obtain position information of the target object in the visible light image; determine position information of the target object in the infrared image based on a spatial positional relationship between the visible light camera and the thermal imaging camera, and the position information of the target object in the visible light image; determine the measured temperature of the target object according to the position information of the target object in the infrared image.

Optionally, the detection result further includes the state of the blackbody. The state includes an occlusion state and a non-occlusion state. The above-described blackbody detection module 406 may include: a position detection unit, configured to perform the blackbody detection on the infrared image through a preset neural network model to obtain the position information of the blackbody in the infrared image and the confidence of the position information; a state determination unit, configured to determine a state of the blackbody according to the position information of the blackbody in the infrared image and the confidence level of the position information.

Optionally, the above state determination unit may be configured to as follows: determine a probability of the blackbody being blocked is 100% in a case where the position information of the blackbody in the infrared image is empty; determine the probability of the blackbody being blocked based on the confidence level of the position information in a case where the position information of the blackbody in the infrared image is non-empty; and determine the state of the blackbody according to the probability of the blackbody being blocked.

Optionally, the above state determination unit may be configured to determine the probability of the blackbody being blocked corresponding to the confidence level of the position information according to a corresponding relationship between the confidence level of preset position information and the probability of the blackbody being blocked, and in the corresponding relationship, the confidence level of the position information is negatively correlated with the probability of the blackbody being blocked.

Optionally, the above state determination unit may be configured to as follows: if the probability of the blackbody being blocked is greater than a preset threshold, determine the state of the blackbody is the occlusion state; if the probability of the blackbody being blocked is less than the preset threshold, determine the state of the blackbody is the non-occlusion state.

Optionally, the above blackbody temperature determination module 408 may be configured to as follows: if the state of the blackbody is the occlusion state, obtain a historical measured temperature of the blackbody in an adjacent specified time period before the acquisition time of the infrared image, and determine the measured temperature of the blackbody corresponding to the acquisition time based on the historical measured temperature of the blackbody; and if the state of the blackbody is the non-occlusion state, determine a region which the blackbody is located in the infrared image based on the position information of the blackbody in the infrared image, determine the temperature of the region represented by the infrared image as the measured temperature of the blackbody corresponding to the acquisition time of the infrared image.

Optionally, the above-described temperature correction module 410 may be configured to use a difference between the measured temperature of the blackbody and the preset temperature of the blackbody as a temperature correction value and correct the measured temperature of the target object based on the temperature correction value.

The implementation principles and technical effects of the devices provided by the embodiments of the present disclosure are the same as those of the above-described embodiments. For a brief description, the parts not mentioned in the device embodiments can refer to the corresponding contents in the above-described method embodiments.

The embodiments of the present disclosure further provide a computer-readable storage medium for use in the above-mentioned temperature measurement method, the temperature measurement device, and the electronic device provided by the embodiments of the present disclosure. The computer-readable storage medium may be configured to store computer program instructions, application programs, and data used and/or generated by the application programs. The computer program instructions are made by application programs to execute steps of the method of any of the above-mentioned embodiments when the computer program instructions are run by a processor, and to store data used and/or generated in the process. The computer program instructions may be configured to execute the methods described in the foregoing method embodiments. For specific implementation, reference may be made to the method embodiments, which will not be repeated here.

Optionally, if the functions of the embodiments of the present disclosure are implemented in the form of software functional units and sold or used as independent products, they may be stored in the computer-readable storage medium. Based on this understanding, the technical solutions of the present disclosure may be embodied in the form of software products in essence, or the parts that make contributions to the prior art or the parts of the technical solutions. The computer software products are stored in a storage medium, including several instructions are used to cause a computer device (which may be a personal computer, a server, or a network device, etc.) to execute all or part of the steps of the methods described in various embodiments of the present disclosure. The above-mentioned storage medium includes: U disk, mobile hard disk, Read-Only Memory (ROM), Random Access Memory (RAM), magnetic disk or optical disk and other media that can store program codes.

To sum up, the temperature measurement method, the temperature measurement device, the electronic apparatus, and the computer-readable storage medium provided by the embodiments of the present disclosure use the characteristics of the blackbody to correct the measured temperature of the target object and calibrates the temperature measurement error caused by the external environment and the temperature measurement device, thereby improving the temperature measurement accuracy. The embodiments of the present disclosure can realize the automatic detection of blackbody based on the neural network model, without manual calibration of the position of the blackbody, thus avoiding the cumbersome and human error of manual calibration, enabling the measured temperature of the blackbody more real and reliable, further improving the reliability of temperature correction, and enabling the corrected temperature measurement results are more accurate.

Those skilled in the art may clearly understand that, for the convenience and brevity of description, for the specific working process of the system described above, reference may be made to the corresponding process in the above-mentioned embodiments, which will not be repeated here.

In addition, in the description of the embodiments of the present disclosure, unless otherwise expressly specified and limited, the terms “installed”, “connect” and “connected to” should be understood in a broad sense, for example, it may be a fixed connection or a detachable connection, or integrally connected; it may be a mechanical connection or an electrical connection; it may be a direct connection, or an indirect connection through an intermediate medium, or an internal communication between two components. For those of ordinary skill in the art, the specific meanings of the above terms in the present disclosure may be understood in specific situations.

Finally, it should be noted that the above-mentioned embodiments are only specific embodiments of the present disclosure to illustrate the technical solution of the present disclosure, but are not limited to this case. The scope of protection of the present disclosure is not limited to this case. Although the present disclosure has been described in detail with reference to the above-mentioned embodiments, those ordinary skilled in the art should understand that any skilled in the art may still modify the technical solution recorded in the above embodiments or easily think of changes, or make equivalent replacement for some of the technical features within the technical scope of the disclosure; these modifications, changes or substitutions do not make the essence of the corresponding technical solution separate from the spirit and scope of the technical solutions of the embodiments of the present disclosure, and should be covered within the protection scope of the present disclosure. Therefore, the protection scope of the present disclosure should be subject to the protection scope of the claims.

### INDUSTRIAL APPLICABILITY

The present disclosure provides a temperature measurement method, a temperature measurement device, an electronic device and a computer-readable storage medium, which alleviates the problem of inaccurate temperature measurement caused by external environment or equipment factors. The automatic detection of the blackbody based on neural network model does not need to calibrate the blackbody position manually, which avoids the cumbersome and human error of manual calibration, enables the measurement temperature of the blackbody more real and reliable, calibrates the temperature measurement errors caused by the external environment and the temperature measuring equipment itself, further improves the reliability of temperature correction, and effectively improves the accuracy of temperature measurement.

1. A temperature measurement method, comprising:
obtaining an image frame pair comprising a target object by a visible light camera and a thermal imaging camera, wherein the image frame pair comprises a visible light image and an infrared image collected simultaneously, and a blackbody is also set in an image acquisition region of the thermal imaging camera;
determining a measured temperature of the target object based on the image frame pair;
performing a blackbody detection on the infrared image to obtain a detection result of the blackbody, wherein the detection result comprises position information of the blackbody in the infrared image;
determining a measured temperature of the blackbody based on the detection result of the blackbody and the infrared image; and
correcting the measured temperature of the target object according to the measured temperature of the blackbody and a preset temperature of the blackbody, wherein a corrected temperature is used as a temperature measurement result of the target object.

2. The method according to claim 1, wherein the determining the measured temperature of the target object based on the image frame pair comprises:
performing a target object detection on the visible light image in the image frame pair to obtain position information of the target object in the visible light image;
determining position information of the target object in the infrared image based on a spatial positional relationship between the visible light camera and the thermal imaging camera, and the position information of the target object in the visible light image;
determining the measured temperature of the target object according to the position information of the target object in the infrared image.

3. The method according to claim 1, wherein the detection result of the blackbody further comprises a state of the blackbody, and the state comprises an occlusion state and a non-occlusion state.

4. The method according to claim 1, wherein the detection result of the blackbody further comprises a size and a shape of the blackbody, wherein whether the distance between the blackbody and the thermal imaging camera is reasonable is determined based on a proportion of the size detected of the blackbody in the infrared image.

5. The method according to claim 1, the performing the blackbody detection on the infrared image to obtain the detection result of the blackbody, comprises:
performing the blackbody detection on the infrared image by using a preset neural network model to obtain the position information of the blackbody in the infrared image and a confidence level of the position information; and
determining a state of the blackbody according to the position information of the blackbody in the infrared image and the confidence level of the position information.

6. The method according to claim 1, wherein the determining the state of the blackbody according to the position information of the blackbody in the infrared image and the confidence level of the position information, comprises:
determining a probability of the blackbody being blocked is 100% in a case where the position information of the blackbody in the infrared image is empty;
determining the probability of the blackbody being blocked based on the confidence level of the position information in a case where the position information of the blackbody in the infrared image is non-empty; and
determining the state of the blackbody according to the probability of the blackbody being blocked.

7. The method according to claim 1, wherein the determining the probability of the blackbody being blocked based on the confidence level of the position information, comprises:
determining the probability of the blackbody, which corresponds to the confidence level of the position information, being blocked according to a corresponding relationship between the confidence level of preset position information and the probability of the blackbody being blocked,
wherein in the corresponding relationship, the confidence level of the position information is negatively correlated with the probability of the blackbody being blocked.

8. The method according to claim 1, wherein the determining the state of the blackbody according to the probability of the blackbody being blocked, comprises:
determining the state of the blackbody is the occlusion state in a case where the probability of the blackbody being blocked is greater than a preset threshold; and
determining the state of the blackbody is the non-occlusion state in a case where the probability of the blackbody being blocked is less than the preset threshold.

9. The method according to claim 1, wherein the determining the measured temperature of the blackbody based on the detection result of the blackbody and the infrared image, comprises:
in a case where the state of the blackbody is an occlusion state, obtaining a historical measured temperature of the blackbody in an adjacent specified time period before acquisition time of the infrared image, and determining the measured temperature of the blackbody corresponding to the acquisition time based on the historical measured temperature of the blackbody; and
in a case where the state of the blackbody is a non-occlusion state, determining a region which the blackbody is located in the infrared image based on the position information of the blackbody in the infrared image, and determining temperature of the region represented by the infrared image as the measured temperature of the blackbody corresponding to the acquisition time of the infrared image.

10. The method according to claim 1, wherein a historical measured temperature of the black body comprises:
an average detected temperature of multiple frames of images of the black body, which is not blocked, in an adjacent specified time period before the acquisition time of a current infrared image; or
an average detected temperature of all frames of images of the black body in an adjacent specified time period before the acquisition time of a current infrared image.

11. The method according to claim 1, wherein the correcting the measured temperature of the target object according to the measured temperature of the blackbody and the preset temperature of the blackbody, comprises:
using a difference between the measured temperature of the blackbody and the preset temperature of the blackbody as a temperature correction value; and
correcting the measured temperature of the target object based on the temperature correction value.

12. A temperature measurement device, comprising:
an image acquisition module, configured to obtain an image frame pair comprising a target object by a visible light camera and a thermal imaging camera, wherein the image frame pair comprises a visible light image and an infrared image collected simultaneously, and a blackbody is also set in an image acquisition region of the thermal imaging camera;
an object temperature determination module, configured to determine a measured temperature of the target object based on the image frame pair;
a blackbody detection module, configured to perform a blackbody detection on the infrared image to obtain a detection result of the blackbody, wherein the detection result comprises position information of the blackbody in the infrared image;
a blackbody temperature determination module, configured to determine a measured temperature of the blackbody based on the detection result of the blackbody and the infrared image; and
a temperature correction module, configured to correct the measured temperature of the target object according to the measured temperature of the blackbody and a preset temperature of the blackbody, wherein a corrected temperature is used as a temperature measurement result of the target object.

13. The device according to claim 12, wherein the object temperature determination module is further configured to:
perform a target object detection on the visible light image in the image frame pair to obtain position information of the target object in the visible light image;
determine position information of the target object in the infrared image based on a spatial positional relationship between the visible light camera and the thermal imaging camera, and the position information of the target object in the visible light image;
determine the measured temperature of the target object according to the position information of the target object in the infrared image.

14. The device according to claim 12, wherein the blackbody detection module comprises:
a position detection unit, configured to perform the blackbody detection on the infrared image through a preset neural network model to obtain the position information of the blackbody in the infrared image and a confidence level of the position information;
a state determination unit, configured to determine a state of the blackbody according to the position information of the blackbody in the infrared image and the confidence level of the position information.

15. The device according to claim 12, wherein the blackbody temperature determination module is further configured to:
in a case where the state of the blackbody is an occlusion state, obtain a historical measured temperature of the blackbody in an adjacent specified time period before acquisition time of the infrared image, and determining the measured temperature of the blackbody corresponding to the acquisition time based on the historical measured temperature of the blackbody; and
in a case where the state of the blackbody is a non-occlusion state, determine a region which the blackbody is located in the infrared image based on the position information of the blackbody in the infrared image, and determine temperature of the region represented by the infrared image as the measured temperature of the blackbody corresponding to the acquisition time of the infrared image.

16. An electronic apparatus, comprising a processor and a storage device,
wherein a computer program is stored on the storage device, and the computer program executes the method according to claim 1 in a case where the computer program executed by the processor.

17. A computer-readable storage medium, wherein a computer program is stored on the computer-readable storage medium, in a case where the computer program is run by a processor, the computer program executes the method according to claim 1.

18. The method according to claim 2, wherein the detection result of the blackbody further comprises a state of the blackbody, and the state comprises an occlusion state and a non-occlusion state.

19. The method according to claim 18, wherein the detection result of the blackbody further comprises a size and a shape of the blackbody, wherein whether the distance between the blackbody and the thermal imaging camera is reasonable is determined based on a proportion of the size detected of the blackbody in the infrared image.

20. The method according to claim 19, the performing the blackbody detection on the infrared image to obtain the detection result of the blackbody, comprises:
performing the blackbody detection on the infrared image by using a preset neural network model to obtain the position information of the blackbody in the infrared image and a confidence level of the position information; and
determining a state of the blackbody according to the position information of the blackbody in the infrared image and the confidence level of the position information.
